(19) United States
(12) Patent Application Publication
(10) Pub. No.: US 2005/0013196 A1
(43) Pub. Date: Jan. 20, 2005

(54) Socket timer with remote

(76) Inventor: Thomas L. Russo, Rutland, VT (US)

Correspondence Address: THOMAS L. RUSSO, 7 AVENUE D, RUTLAND, VT, 05701, US

(21) Appl. No.: 10/621,566

(22) Filed: Jul. 17, 2003

(51) Int. Cl. G04B 47/00

(52) U.S. Cl. 368/10

(57) ABSTRACT

Socket Timer with remote is a light timing system consisting of a remote unit that programs a time keeping unit in a socket timer unit. Socket Timer with remote program as a system allows the remote to program individual socket timer units to provide a selection of timed events. Socket Timer with remote program controls time events at the bulb, allowing a wide range of lighting fixtures and fixture types supporting different power input formats with a variety of power switching methods and types the capability of providing a scheduled timed on and off sequence at predetermined times in a given period.

### BACKGROUND OF INVENTION

This invention relates to light timing units. Where the need to control lighting on a scheduled format has in the past been accomplished by digital program switches, lamp cord receptacle units, dawn to dusk units, and socket timers. Where each of these past and current formats has its appropriate application, this invention was designed to improve the use of the socket timer that provides timing at the bulb. Providing timing at the bulb allows the possibility of timed events to occur for a wider range of electrical fixture types and styles. In the digital program switches, the switch units are hard wired in place of the conventional on-off wall switch and timing is controlled at the switch level. Controlling a timed event at the switch controls every bulb in the fixture at the same time for the same duration and the same sequence. Timer units that are designed for lamp cord receptacles focus on lamp-based fixtures only and do not allow for timed events in fixtures that would be hardwired into the normal electrical circuitry and switches found in most homes and businesses. Dawn to dusk timer do allow for bulb level control but do not allow for timed event sequences especially in indoor use. Socket timers allow for at the bulb use of timed events in a wide range of fixture types with a wide range of switch types and styles. Socket timers allow for the control of each bulb in a single fixture to be programmed for a different or for the same timed event sequences, an application of this individual bulb programming, may be to provide different light levels in an area from a single light fixture. Socket timers allow for light in the same fixture to be add gradually over a period, by first timing one bulb on, then at a later time turning a second bulb on, and at a later time a third bulb, etc. Light levels with at the bulb timing can also diminish light gradually over a period, by scheduling individual bulbs to turn off at different times in a select period, providing a wider range of light sequencing control periods.

Current timed events currently using digital program switches, lamp cord receptacles and socket timers all require a setting of sequenced events at the switch or timer. This invention the Socket Timer with Remote provides for time setting and scheduled event programming in the remote unit, and then by directing the remote unit toward the socket timer to be programmed and pressing the required transmit key or keys, the socket in that fixture will now provide the timed event sequence transmitted from the remote unit. The advantage to this invention is the ability to set time and pre program different timed events in the remote unit and then to set and control as many socket timers with remote control capability by just directing the signal from the remote toward the socket timer that requires a time set or reset and the setting of a timed event schedule, the remote unit of the invention provides an efficient operation as it can be set for current time and a number of timed event programs and its programmed time and time events can be used to set many socket timers with remote control capabilities, through the remote unit's transmitted signal to the socket timer unit's remote controlled time unit receiver. All information for time setting and light timed event schedules are accomplished without the need to take each unit in hand and reset the same time and timed events over and over again. Simply direct the remote unit with its pre set time and timed event programs toward the selected socket timer unit with remote capabilities, press the require key or keys and the socket timer is set with current time and select tim d event programs.

The first embodiment of this invention is focused on socket timing with remote controlled time setting and light ev nt timing for all existing fixtures, a portable screw-in type socket, FIG. 1, will convert a standard socket fixture into a timed socket with remote programming with no need for hard wiring. The remote unit that completes this system will allow the setting of many fixtures with socket timers with remote control capabilities with no physical contact, the remote unit facilitates resetting time and setting timed events in a single remote unit in the palm of your hand. Once a remote is set with proper time and a selection of timed event schedules the remote is used to then transmit that information to a socket timer with remote capabilities in any fixture. The wide range of timed sequencing provided by a socket timer with the convenience of programming time and timed light events from a remote unit, is better understood when we consider a rather simple time situation, for example, changes in daylight saving time requires changes in all light timing devices throughout a household or business to ensure that the required timed event will occur in the most effective daylight or night time periods. This simple time situation change would require an at the switch or timer device adjustment for every device with a timed event schedule, some fixtures maybe out of easy reach, and require additional efforts to be reset. The repetitive process of resetting each timer at the timer or switch with the same information regarding a time change is now reduced to one reset entry, this is accomplished through the invention by resetting a single remote unit in the palm of your hand, directing this remote to a selected socket timer unit with remote capabilities to transmit and update the current correct time and any new timed event schedules with the press of a key or keys provided on the remote unit. Then moving to the next selected socket timer with remote capabilities directing the remote toward the timer unit and transmit th updated information, continu throughout the household or business until all updates ar complete with a simple point and press of the remote unit that is part of the socket timer with r mote system. A socket timer with remote will allow owners with different physical capacity the ability to change settings and light timed events in every socket timer with remote capabilities with a simple point and press procedure to transmit the updated signal for all new settings.

A second embodiment of this socket timer invention is to make the socket timer with remote features a part of all new production lamp and light fixture sockets. This will be accomplished by placing the socket timer remote receiving and timer unit, into a standard production light fixture socket where the remote receiving and timer unit, becomes an integral part of all new electrical fixture sockets for hardwired ceiling and wall fixtures, as well as all lamp and lamp type fixtures. As manufactures develop and create new lamp and light fixture units the socket timer will be part of every unit allowing any and all fixtures to provide timed event sequencing through the integrated socket timer receiving unit with remote control capabilities. Using the same remote mentioned above for the portable Socket Timer unit both portable screw-in socket timer units with remote capabilities here in referred to as Socket Timer with remote and socket timers with remote capabilities that are an integral part of lamp and light sockets, herein referred to as Production Socket Timer with remote, can be programmed for time settings and timed event sequences. The flexibility and versatility of the remote units in the Socket timer with remote capabilities, for both portable screw-in Socket Timer units and Production Socket timer units, supports the efficient use of the invention by allowing a single setting in a remote to be transmitted to any portable Socket Timer or Production Socket Timer with a simple point and press format to update timed event schedules or reset current time.

### SUMMARY OF THE INVENTION

The invention is designed to meet the above requirements and provide a simple and flexible light timing system. The Socket Timer with remote program system provides bulb level control convenience and safety of preprogrammed timed lighting. The Socket Timer with remote program provides the setting features in the remote unit and that program information is transmitted to the Socket Timer by directing the remote unit toward the selected Socket Timer with remote an pressing the key or keys required to transmit current time and timed event schedules. A second embodiment of this socket timer is placing the socket timer remote receiving and timer unit into a standard production light fixture socket where the remote receiving and timer unit becomes an integral part of all new electrical fixture sockets for hardwired ceiling and wall fixtures, as well as all lamp and lamp type fixtures. For a better understanding of the structure of the invention and its function, further explanation is given below with reference to the attached drawings.

### DESCRIPTION OF THE DRAWINGS

FIG. 1 view of Socket Timer unit that would be part of the Socket Timer with remote system, this view illustrates the socket contact for electrical service (1), Socket screw designed metal fitting, to fit into electrical fixtures bulb socket (2), to conduct electrical energy into the remote receiving and time units FIG. 8, of the Socket Timer positioned at an area behind the bulb to be controlled (3), the bulb to be controlled would be inserted into the Socket Timer (4), as an optional feature a socket indicator light can be included to provide a light signal indicating that the socket timer remote unit is ready to receive time setting and timed sequence transmissions and to indicate when the transmission is complete (5), units without this optional indicator light (5), could use the bulb controlled by socket timer to indicate the socket timer is ready for transmission, by using for example a blinking sequence in the actual fixture bulb. Socket Timer unit readiness can also be indicated in the remote unit, through an optional indicator light on the remote unit, FIG. 12 (5), or through a code display or display screen feature that identifies a signal connection has been obtained between the remote unit and the select Socket Timer with remote FIG. 2 (2), FIG. 12 (2), To place a Socket Timer with remote capabilities into a lamp or light fixture, hold the unit by the body of the socket timer unit (6), and insert the socket timer contact area (7) into the selected lamp or light fixture light bulb socket, insert the light bulb to be controlled by the socket timer with remote into the bulb receiving opening (4), turn power on to the lamp or light fixture, direct the selected remote FIG. 2, FIG. 12, with a pre programmed time setting and light timed events toward the s I cted Socket Timer unit, press the transmit key or keys FIG. 2 (3),FIG 12 (3), that will send th programmed time setting and light timed events to the socket timer FIG. 1 (3), once program information is received by socket timer FIG. 1 (3), the light bulb inserted in the socket timer (4), will operate with the selected timed events transmitted from the remote unit FIG. 2, FIG. 12.

FIG. 2 view illustrating a Socket Timer remote unit, remote units can contain any number and arrangements of functions and features. A remote unit developed using any current or future technology that can hold entered data and time information and will transmit that entered data or time information signals to the Socket Timer remote controlled time keeper receiver unit that is capable of receiving the transmitted remote signals sent from the remote unit, in order to set time and schedule timed lighting events, will be considered an acceptable remote unit of the Socket Timer with Remote system. FIG. 2 illustrates a possible type and style of a remote unit that will control a socket timer with remote program capabilities. Remote unit body (1), can contain components that provide a wide range of features an functions, A feature of a remote could support a display screen (2); where time setting and program setting can be viewed, A key pad (3), will allow time settings and timed event sequences to be entered into the remote unit. Key pads can contain a simple up and down arrow FIG. 12 (6), for time selection and event timing or a complete alpha numeric keypad to enter time settings and timed event sequences. Remote unit programs can contain one on-off function for a single event per day, or the remote unit can contain many separate event programs for multiple programmed timed events in a single day or different events over several periods, or to hold many programs to be used on different socket timers with remote programs through out a home or business. Remote units are directed at socket timer with remote capabilities where any current or future technology that will transmit a signal (4), to a socket timer unit and provides the connection between the remot unit FIG. 2, and the selected socket timer unit FIG. 1, FIG. 10, FIG. 11, FIG. 13, FIG. 14 in order to provide time setting and timed event schedule for the select socket timer unit FIG. 1, FIG. 10, FIG. 11, FIG. 13, FIG. 14.

FIG. 3 see-through view of Socket Timer unit of a socket timer with remote system, highlighting socket contact of electrical service (1), Socket screw designed metal fitting, to fit into electrical fixtures bulb socket (2), to conduct electrical energy into the remote receiving and time units FIG. 8, of the Socket Timer positioned at an area behind the bulb to be controlled, A remote controlled time keeper receiver unit developed using any current or future technology that can receive transmitted remote signals to set time and schedule timed lighting events. (3), Opening in unit bottom to receive light bulb (4), as an optional feature a socket indicator light (5), can be included to provide a light signal indicating that the remote unit is ready to receive time setting and timed sequence transmissions and that the transmission is complete, units without this optional indicator light (5), could use the bulb in the socket timer itself to indicate the socket timer is ready for transmission, for example by using a blinking sequence in the actual fixture bulb. Socket Timer unit readiness can also be indicated in the remote unit, through an optional indicator light represented on the remote unit, represented in FIG. 12 B (5), or through a code display or display screen feature that identifies a signal connection has been obtained between the remote unit and the select Socket Timer with remote FIG. 2 (2) FIG. 12 (2), the body of the socket timer unit (6) supports the upper half of Socket Timer body, containing metal screw socket connection (7), that deliv rs power to timer keeper receiver unit and the fixture or lamp light bulb.

FIG. 4 see-through view of Socket Timer unit of a socket timer with remote system, highlighting lamp or light fixture light bulb to be controlled by socket timer with remote (1), Socket screw designed metal fitting, to fit into electrical fixtures bulb socket (2), to conduct electrical energy into the remote receiving and time units FIG. 8, of the Socket Timer positioned at an area behind the bulb to be controlled, A remote controlled time keeper receiver unit developed using any current or future technology that can receive transmitted remote signals to set time and schedule timed lighting events. (3), Opening in unit bottom to receive light bulb (4), the body of the socket timer unit (6) supports upper half of Socket Timer body, containing metal screw socket connection (7), that delivers power to timer keeper receiver unit and the fixture or lamp light bulb (9). as an optional feature a socket indicator light can be included to provide a light signal indicating that the remote unit is ready to receive time setting and timed sequence transmissions and that the transmission is complete (5), units without this optional indicator light (5), could use the bulb (8)(9) in the socket timer itself to indicate the socket timer is ready for transmission, by using a blinking sequence in the actual fixture bulb (8) (9). Socket Timer unit readiness can also be indicated in the remote unit, through an optional indicator light FIG. 12B (5), on the remote unit, or through a code display or display screen feature that identifies a signal connection has been obtained between the remote unit and the select Socket Timer with remote FIG. 2 (2), FIG. 12 (2),

FIG. 5 perspective view of Socket Timer in two sections, highlighting a remote controlled time keeper receiver unit (3), developed using any curr nt or future technology that can receive transmitted remote signals to set time and schedule timed lighting events. socket contact for electrical service (1), Socket screw designed metal fitting, to fit into electrical fixtures bulb socket (2), to conduct electrical energy into the remote receiving and time units FIG. 8, of the Socket Timer positioned at an area behind the bulb to be controlled, A remote controlled time keeper receiver unit developed using any current or future technology that can receive transmitted remote signals to set time and schedule timed lighting events. (3), Opening in unit bottom to receive light bulb (4), optional indicator light (5), the body of the socket timer unit (6) supports upper half of Socket Timer body, containing metal screw socket connection (7), that delivers power to timer keeper receiver unit and the fixture or lamp light bulb

FIG. 6 exploded view of Socket Timer unit sections, socket contact for electrical service (1), Socket screw designed metal fitting, to fit into electrical fixtures bulb socket (2), to conduct electrical energy into the remote receiving and time units FIG. 8, of the Socket Timer positioned at an area behind the bulb to be controlled, A remote controlled time keeper receiver unit developed using any current or future technology that can receive transmitted remote signals to set time and schedule timed lighting events. (3), Opening in unit bottom to receive light bulb (4), as an optional feature a socket indicator light (5), can be included to provide a light signal indicating that the remote unit is ready to receive time setting and timed sequence transmissions and that the transmission is complete, units without this optional indicator light (5), could use the bulb in the socket timer its If to indicate the socket timer is ready for transmission, by using a blinking sequence in the actual fixture bulb. Socket Timer unit readiness can also be indicat d in th remote unit, through an optional indicator light on the remot unit, represented in FIG. 12 B (5), or through a code display or display screen feature that identifies a signal connection has been obtained between the remote unit and the select Socket Timer with remote represented in FIG. 2 (2), FIG. 12 (2). To place a Socket Timer with remote capabilities into a lamp or light fixture, hold the unit by the body of the socket timer unit (6), and insert the socket timer contact area (7) into the selected lamp or light fixture light bulb socket, insert the light bulb to be controlled by the socket timer with remote into the bulb receiving opening (4), Upper half of Socket Timer body, containing metal screw socket connection (7), that delivers power to timer keeper receiver unit and the fixture or lamp light bulb, Metal screw insert to receive socket end of lamp or light fixture light bulb (8).

FIG. 7 cutaway views of Socket Timer unit highlighting power transfer from lamp or light fixture socket represented with elements (9) and (10), socket contact for electrical service (1), Socket screw designed metal fitting, to fit into electrical fixtures bulb socket (2), to conduct electrical energy into the remote receiving and time units FIG. 8, of the Socket Timer positioned at an area behind the bulb to be controlled, A remote controlled time keeper receiver unit developed using any current or future technology that can receive transmitted remote signals to set time and schedule timed lighting events. (3), Opening in unit bottom to receive light bulb (4), To place a Socket Timer with remote capabilities into a lamp or light fixture, hold the unit by the body of the socket timer unit (6), and insert the socket timer contact area (7) into the selected lamp or light fixture light bulb socket, insert the light bulb to be controlled by the socket timer with remote into the bulb receiving opening (4), Upper half of Sock t Timer body, containing metal scr w socket connection (7), that delivers power to timer keeper receiver unit and the fixture or lamp light bulb, Metal screw insert to receive socket end of lamp or light fixture light bulb (8).

FIG. 8 plan view representing the Socket Timer unit, and the Production Socket Timer units remote receiving and time units FIG. 8, the remote receiving time unit is positioned at an area behind the bulb to be controlled, A remote controlled time keeper receiver unit developed using any current or future technology that can receive transmitted remote signals to set time and schedule timed lighting events. The receiver time unit, receives the programmed time and timed event schedules from a remote unit, power from the fixture moves through to the receiver time unit where it energizes the necessary components to maintain time and timed event settings, the power through the fixture is held at the receiver time unit until the time keeper unit in the receiver time unit reaches the first light-on programmed timed event transmitted by the remote unit and received by the receiver time unit, then the receiver time unit allows the fixture power to move through the receiver time unit to light the bulb in the socket timer unit, power will continue through the receiver time unit to the controlled bulb until the time keeper unit in the receiver time unit reaches the pre selected light-off time transmitted by the remote unit and received by the receiver time unit. The number an type of preset timed event program schedules in any given period will be determined by the features provided by the selected remote unit and the receiver time units program capacity. Socket timer and Production Socket timer systems could provide one timed event per period or multiple events in a single period or over several periods, providing a very flexible timed event programming system.

FIG. 9 view of Socket Timer with remote capability FIG. 1, highlighting attachment of lamp or light fixture bulb, ready to be inserted into lamp or light fixture socket as an optional feature a socket indicator light (5), can be included to provide a light signal indicating that the remote unit is ready to receive time setting and timed sequence transmissions and that the transmission is complete. FIG. 9B view of Socket Timer with remote capability highlighting attachment of lamp or light fixture bulb, ready to be inserted into lamp or light fixture socket. Without an optional indicator light, units without this optional indicator light, could use the bulb in the socket timer itself to indicate the socket timer is ready for transmission, by using a blinking sequence in the actual fixture bulb. Socket Timer unit readiness can also be indicated in the remote unit, through an optional indicator light on the remote unit, represented in FIG. 12B (5), or through a code display or display screen feature that identifies a signal connection has been obtained between the remote unit and the select Socket Timer with remote FIG. 2 (2) FIG. 12 (2),

FIG. 10 view of Socket Timer unit (1) representing a socket timer unit in FIG. 1, with remote capability in a ceiling or wall permanent fixture controlled by a conventional wall switch (2)

FIG. 11 view of Socket Timer unit (1) with remote capability, representing a socket timer unit in FIG. 1, in a table or floor lamp fixture controlled by a lamp socket switch. (2) as an optional feature a socket indicator light (5), can be included to provide a light signal indicating that the remote unit is ready to receive time setting and timed sequence transmissions, indicating for example the transmission is complete,

FIG. 12 view illustrating a Socket Timer remote unit, remote units can contain any number and arrangements of functions and features, remote unit developed using any current or future technology that will transmit signals to the Socket Timer remote controlled time keeper receiver unit that can receive the transmitted remote signals sent from the remote unit to set time and schedule timed lighting events. FIG. 12 illustrates a possible type and style of a remote unit that will control a socket timer with remote program capabilities. Remote unit body (1), can contain components that provide a wide range of features an functions, A feature of a remote could support a display screen (2); where time setting and program setting can be viewed, A key pad (3),will allow time settings and timed event sequences to be entered into the remote unit. Key pads can contain a simple up and down arrow (6), for time selection and event timing or a complete alpha numeric keypad to enter time settings and timed event sequences. Remote unit programs can contain one on-off function for a single event per day, or the remote unit can contain many separate event programs for multiple programmed timed events in a single day or different events over several periods, or to hold many programs to be used on different socket timers with remote programs through a home or business. Remote units are directed at socket timer with remote capabilities where any current or future technology that will transmit a signal (4), to a socket timer unit and provides the connection between the remote unit FIG. 12, and the selected socket timer unit like that represented in FIG. 1, FIG. 10, FIG. 11, FIG. 13, FIG. 14, in order to provide time setting and timed event schedule for th sel ct socket timer unit as that represented in FIG. 1, FIG. 10, FIG. 11, FIG. 13, FIG. 14. FIG. 12B illustrates the r mote in FIG. 12 with an optional indicator light (5), Sock t Tim r unit readiness can be indicated in the remote unit, through an optional indicator light on the remote unit, represented in FIG. 12 B (5), or through a code display or display screen feature that identifies a signal connection has been obtained between the remote unit and the select Socket Timer with remote FIG. 12(2), FIG. 12 (2),

FIG. 13 view of Production Socket Timer unit, highlighting lamp socket design illustrating remote controlled time keeper unit FIG. 8, position and lamp socket switch placement (1) Lamp power cord to conduct electrical energy into the remote and time units FIG. 8, of the Production Socket Timer (3),and then on to the lamp light bulb (4), or bulbs inserted into the Production Socket Timer/Timers. (2), Optional indicator light illustrates a Production Socket Timer style that can provide a light signal indicating that the remote unit is ready to receive time setting and timed sequence transmissions, units without this optional indicator light will use the bulb (4), in the socket timer itself to indicate the socket timer is ready for transmission, for example by using a blinking sequence in the actual fixture bulb. Socket Timer unit readiness can also be indicated in the remote unit, through an optional indicator light on the remote unit, represented in FIG. 12B (5), or through a code display or display screen feature that identifies a signal connection has been obtained between the remote unit and the select Socket Timer with remote represented in FIG. 2 (2),

FIG. 14 view of Production Socket Timer unit, highlighting lighting fixture socket design illustrating remote controlled time keeper unit FIG. 8, position and light fixture socket (1) electric power conducts electrical energy into the wall switch (5), and on to the Production Socket Timer with remote (1), through the remote time unit receiver FIG. 8, of the Production Socket Timer (3), and then on to the lamp light bulb (4), or bulbs inserted into the Production Socket Timer/ Timers. Optional indicator light (2), illustrates a Production Socket Timer style that can provide a light signal indicating that the remote unit is ready to receive time setting and timed sequence transmissions, units without this optional indicator light will use the bulb (4), in the socket timer itself to indicate the socket timer is ready for transmission, by using for example a blinking sequence in the actual fixture bulb. Socket Timer unit readiness can also be indicated in the remote unit, through an optional indicator light on the remote unit, represented in FIG. 12B (5), or through a code display or display screen feature that identifies a signal connection has been obtained between the remote unit and the select Socket Timer with remote represented in FIG. 2 (2),

### DESCRIPTION OF PREFERRED EMBODIMENTS

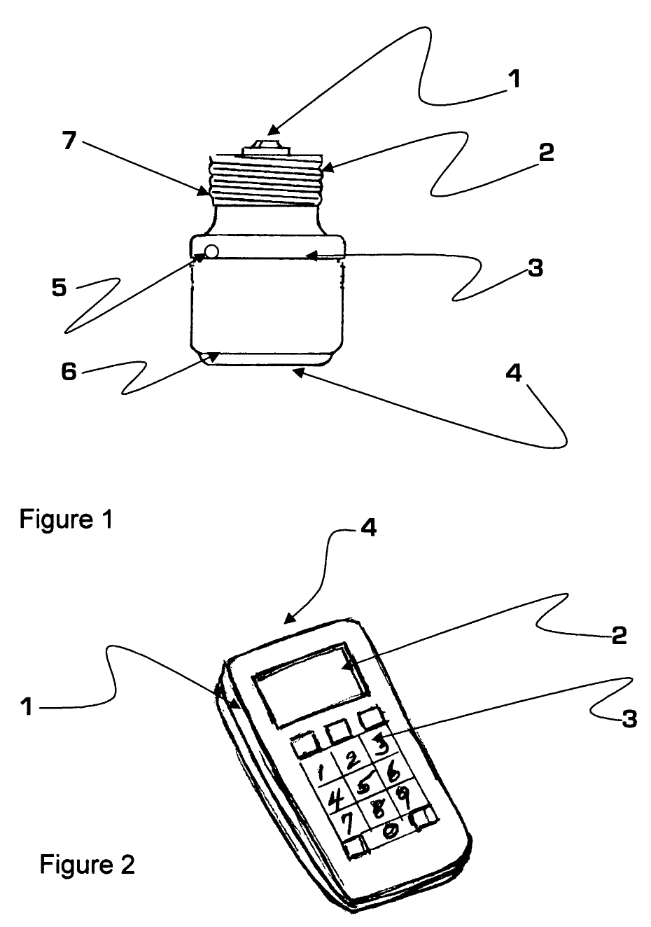

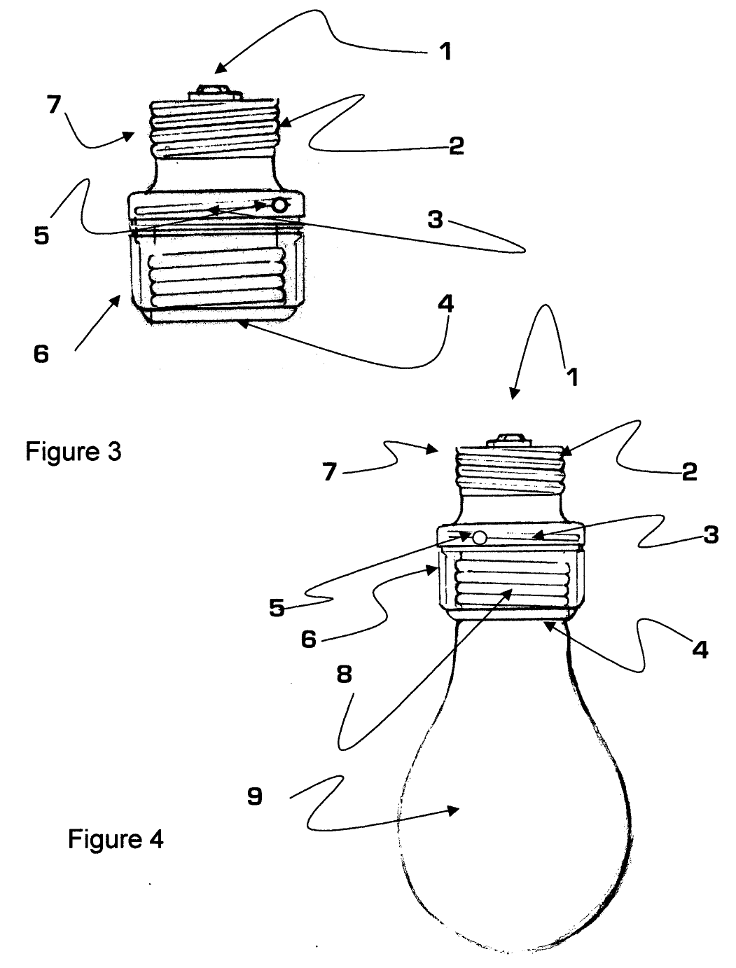

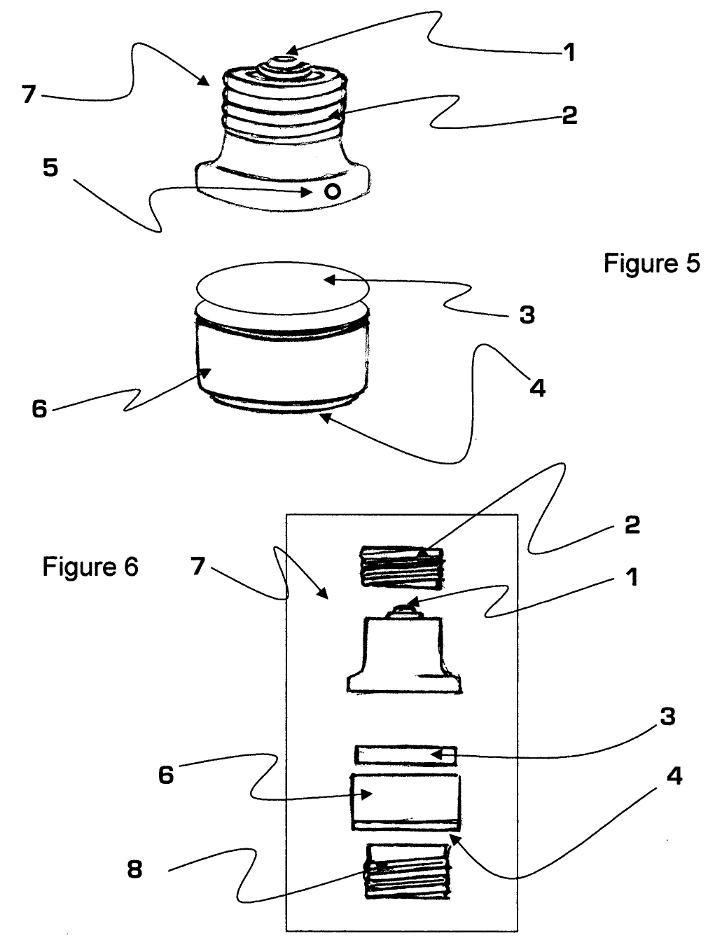

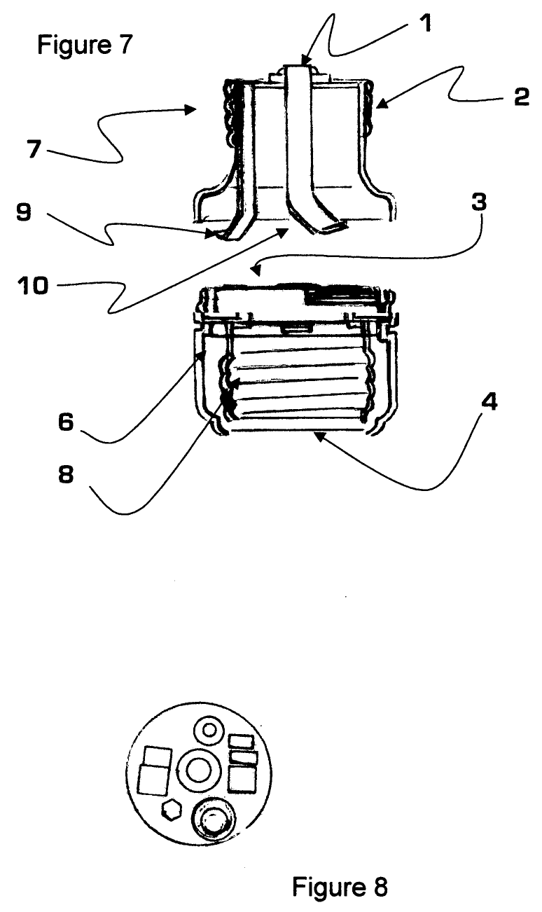

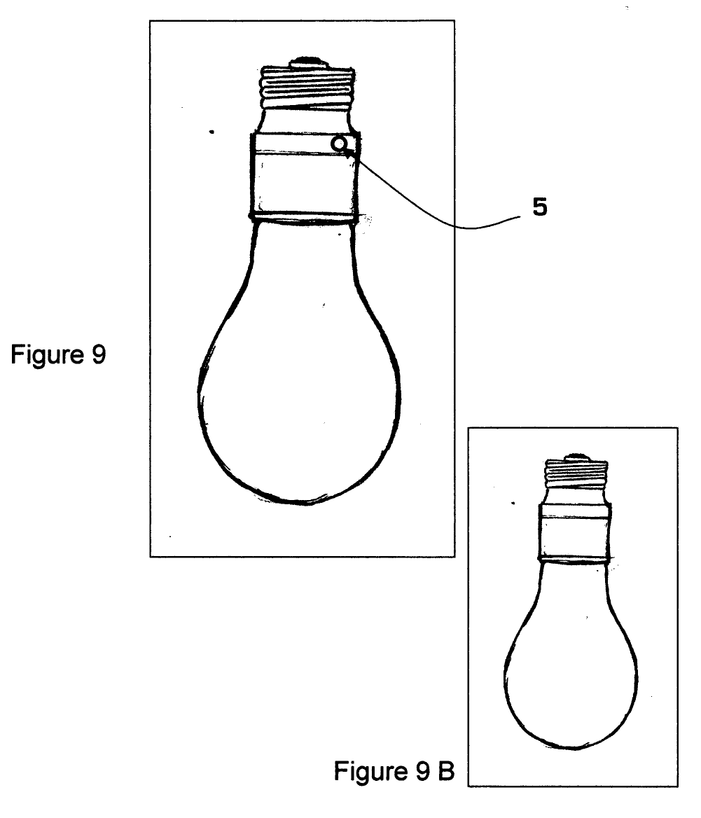

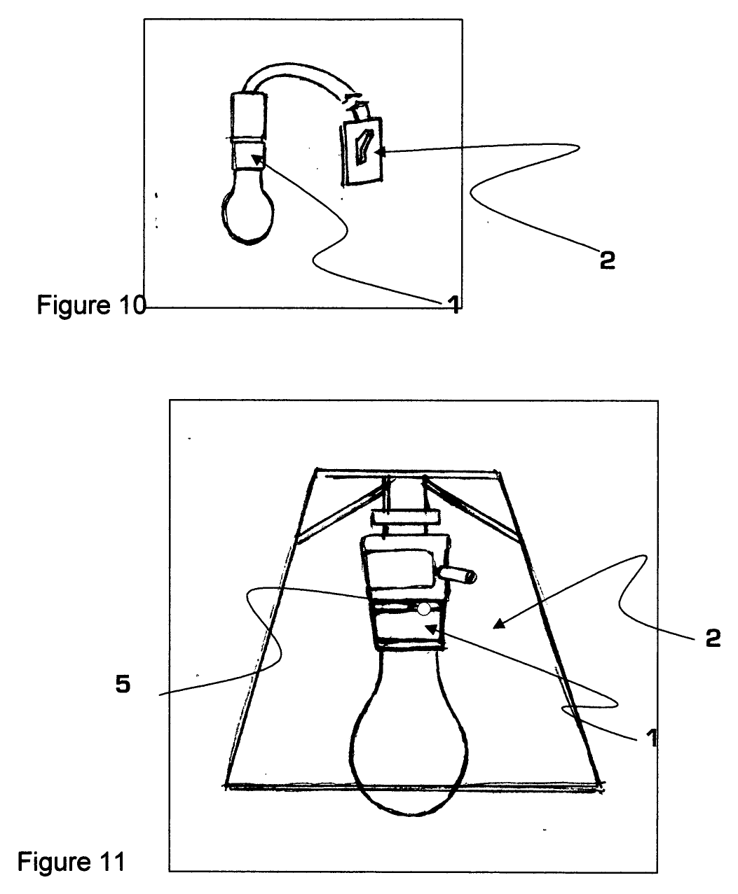

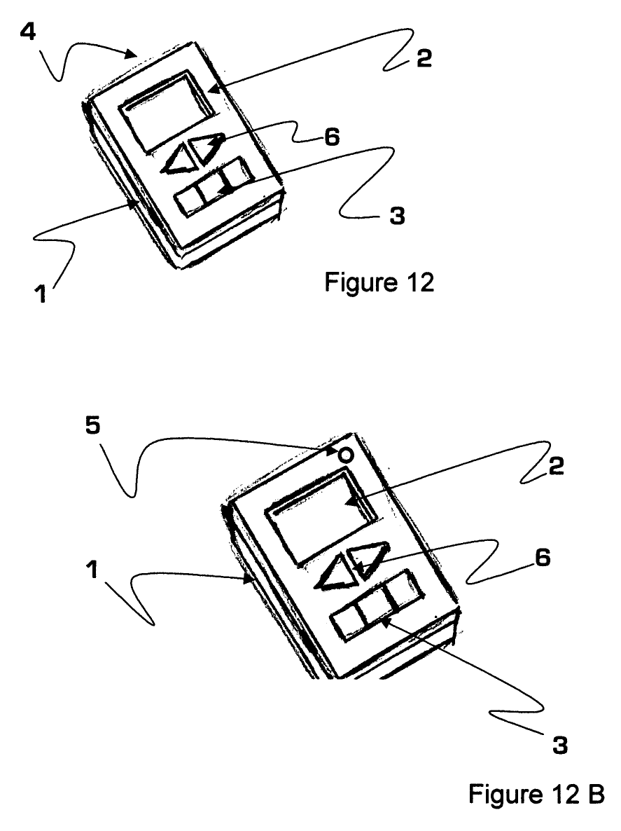

As shown in FIG. 1, the Socket Timer with remote programming is placed into a socket of a standard light fixture or lamp fixture, once in place a standard light bulb is placed into the socket timer bulb receiving area FIG. 1 (4). With the bulb in place turn the power on to the fixture or lamp, programming of the Socket timer FIG. 1, will be accomplished with the use of a remote unit, represented in FIG. 2 illustrating a general type and style of remote but by no means suggests this is the only type or style of remote able to provide programming of the Socket Timer with remote programming FIG. 1. Remotes can have a wide range of functions and features, or can have a few select functions and feature to set time and program scheduled timed lighting events. FIG. 2 remote illustrates a multiple line screen display FIG. 2 (2) that allows the setting of the current time on line 1 and to select a on-time on line 2 and an off-time on line 3. Once the on and off time are selected and appear on the display represented in FIG. 2 (2), a program number is selected. For example Light-on at 7 am and light-off at 9 am could be identified as program 1. Remotes can have an unlimited number of program setting or just one or two. To set a Socket Timer with remote program direct the forward end of the remote FIG. 2 (4), toward the Socket Timer FIG. 1, FIG. 10, FIG. 11, with remote program, press the require remote transmit key or keys FIG. 2 (3), FIG. 12 (3), if the Socket Timer has an indicator light FIG. 1 (5), FIG. 9 (5), FIG. 11 (5), it will provide an indication that the socket timer is ready to receive a time setting and timed event schedule. The indicator light could for example blink once to indicate it is ready to receive the time settings and timed event schedules from a selected remote FIG. 2, FIG. 12, or it could for example blink multiple times to indicate its readiness to receive remote programming, an indicator light FIG. 1 (5), FIG. 12B (5), is a feature whose function could contain a wide range of sequ nces and formats and that will be determined by the numb r of features and programs contained in a remote type and style FIG. 2, FIG. 12. Socket Timers without an indicator light FIG. 9B, FIG. 10, will use the standard bulb FIG. 9B, that has been inserted in its bulb receiving area represented in FIG. 1 (4) and FIG. 4 (4), to indicate the Sockets readiness to receive programming, the bulb represented in FIG. 4 (9), could for instance blink once to indicate it is ready to receive time settings and timed event schedules, or it can blink multiple times to indicate its readiness to receive remote programming, Socket Timer with remote program sockets may not provide readiness indicators on the socket but rather on the remote unit FIG. 2, FIG. 12, an indication of readiness could be a blink of the display screen FIG. 2 (2), FIG. 12 (2), or a readiness code could appear in the display screen FIG. 2 (2), FIG. 12 (2), the remote unit could itself have an indicators light FIG. 12B (5). Type and duration of indicator readiness is merely a feature preference and will only support the usefulness of the Socket Timer with remote programming in the hands of many different users. Once there is an established connection between a remote unit FIG. 2, FIG. 12, and the selected Socket Timer unit FIG. 1, FIG. 10, FIG. 11, through indicator lights or codes as discussed above, pressing the time set key or keys on the selected remote FIG. 2, FIG. 12, will send the remote unit signal containing time and event timed setting to the remote receiver time unit FIG. 8, in the select Socket timer with remote capabilities and will set the Socket Timer units current time and timed event setting, pressing the selected program key or keys on the select remote FIG. 2 (3), FIG. 12 (3), will set the timed event sequence in the Socket Timer unit FIG. 1, FIG. 10, FIG. 11, providing for the timed event schedule at the bulb for the s lected fixture or lamp. One remote unit as Illustrated in FIG. 2, FIG. 12, could program an unlimited number of Socket Timers FIG. 1, FIG. 10, FIG. 11, with remote program capabilities. Remot unit FIG. 2, FIG. 12, may support a time featur that keeps the current time once programmed in addition to storing many timed event schedules in a memory chip or similar device available with current technology as well as future technology storage features, information storage within the remote unit allows for repeat use of all programs and features, and reduce the need for reprogramming. Remote units can have features to turn selected fixtures and lamps containing a Socket Timer unit on and off in a manner similar to a simple remote on-off switch, The invention would provide each Lamp and light fixtures to be operated by their standard switches for on-off operations without removing the Socket Timer units FIG. 1, FIG. 10, FIG. 11.

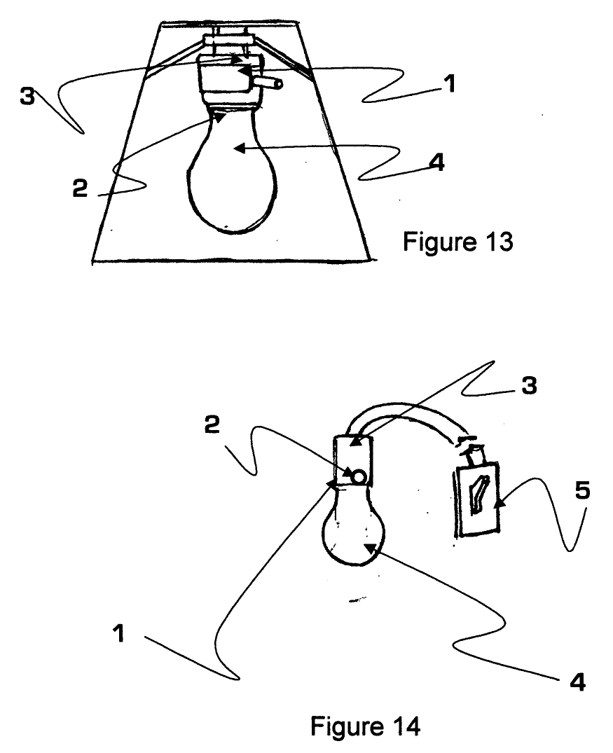

As represented in FIG. 13, FIG. 14, the Production Socket Timer with remote programming is an integral part of a socket of a standard light fixture or lamp fixture, a standard light bulb FIG. 13 (4), FIG. 14 (4), is placed into the lamp or fixture socket containing the socket timer remote receiving time unit FIG. 8, integrated in production timer socket represented in FIG. 13 (4), FIG. 14 (4), To schedule a timed event in a Production Socket Timer ensure the bulb is in the production socket timer FIG. 13 (4) FIG. 14 (4), turn the power on to the fixture or lamp, programming of fixture or lamp socket containing the Socket timer remote and time unit FIG. 8, position FIG. 13 (3), FIG. 14 (3), will be accomplished with the use of a remote unit ,represented in FIG. 2, FIG. 12, FIG 2 and FIG. 12 illustrate a general type and style of remote but by no means suggests this is the only type or style of remote able to provide programming of the Production Socket Timer FIG. 13, FIG. 14, with remote programming but it is intended that the same remote that will program a Socket Timer with remote program FIG. 1, FIG. 10, FIG. 11, will also be abl to program a Production Socket Timer with remote program FIG. 13, FIG. 14. Remote units FIG. 2, FIG. 12, can have a wide range of functions and features, or just a few sel ct functions and features to set time and program scheduled timed lighting events. FIG. 2 remote illustrates a multiple line screen display FIG. 2 (2) that allows the setting of the current time on line 1 and to select a on-time on line 2 and an off-time on line 3. Once the on and off time are selected and appear on the display FIG. 2 (2), a program number is selected. For example Light-on at 7 am and light-off at 9 am could be identified as program 1. Remotes can have an unlimited number of program settings or just one or two. To set a Production Socket Timer with remote program FIG. 13, FIG. 14, direct the forward end of the remote FIG. 2 (4), FIG. 12 (4), toward the Production Socket Timer with remote program FIG. 13, FIG. 14, press the required remote unit transmit key or keys FIG. 2 (3), FIG. 12 (3), if the Production Socket Timer has an indicator light FIG. 14 (2), it will provide an indication that the production socket timer FIG. 13, FIG. 14, is ready to receive a time setting and timed event schedule. As stated above, the type and duration of indicator readiness is merely a feature preference and will only support the usefulness of the Production Socket Timer with remote programming in the hands of many different users. Once there is an established connection between the remote unit and the remote receiver time unit FIG. 8, in the selected Production Socket Timer unit, through indicator lights or codes as discussed above, pressing the time set key or keys on the select remote unit FIG. 2 (3), FIG. 12 (3), will set the Production Socket Timer units FIG. 13, FIG. 14, current time, pressing the selected program key or keys on the select remote unit FIG. 2 (3), FIG. 12 (3), will set the timed event sequence in the Production Socket Timer unit FIG. 13, FIG. 14, providing for the timed event schedule at the bulb for the selected fixture or lamp. One remote unit as Illustrated in FIG. 2, FIG. 12, could program an unlimited number of Production Socket Tim rs FIG. 13, FIG. 14, with remote program capabilities. A remot unit time feature that stores the current time once programmed and stores multiple programs for many timed event schedules in a memory chip or similar current technology as well as future storage technology that will provide storage capability within the remote unit allowing the repeat use of all programs and features. Remote units represented in FIG. 2, FIG. 12, features may provide a simple on-off operation to turn selected light fixtures and lamps containing a Production Socket Timer unit FIG. 13, FIG. 14, on and off in a manner similar to a simple remote switch, the invention provides a timer bypass for Lamp and light fixtures with the integrated remote receiver time unit FIG. 8, of the Production Socket Timer in order to operate lamp and light fixtures with production socket timers by their standard socket switch formats. In this manner the invention provides a very flexible timed event system for production socket timer lamps and fixtures.

1. The Socket Timer with remote program will provide remote time setting and remote timed events sequencing to a light bulb inserted into a Socket Timer with remote programming that is inserted in the socket of a light or lamp fixture.

2. The Production Socket Timer with remote program will provide remote time setting and remote timed events sequencing to a light bulb inserted into a lamp or light fixture that has the Production Socket Timer with remote programming timer and remote unit as an integral part of its fixture socket or sockets.
